(19) United States
(12) Patent Application Publication
(10) Pub. No.: US 2023/0147496 A1
(43) Pub. Date: May 11, 2023

(54) Wearable Vegetable Collecting Device

(71) Applicant: José Antonio MÁRQUEZ DOMÍNGUEZ, Palos de la Frontera (ES)

(72) Inventor: José Antonio MÁRQUEZ DOMÍNGUEZ, Palos de la Frontera (ES)

(21) Appl. No.: 17/911,584

(22) PCT Filed: Mar. 2, 2021
(86) PCT No.: PCT/EP2021/055190

§ 371 Date: Sep. 14, 2022

(30) Foreign Application Priority Data
Mar. 16, 2020 (ES) U202030485

(51) Int. Cl. A01D 46/22; A41D 19/00

(52) U.S. Cl. CPC A01D 46/22; A41D 19/0037

(57) ABSTRACT

A wearable vegetable collecting device includes a main body that is configured to be worn on a hand, wrist or arm, and a receptacle attached to the main body at an attachment area of the main body, the receptacle includes an opening whereby a vegetable can be deposited in the receptacle.

### FIELD OF THE INVENTION

The present invention relates to the field of wearable collecting devices and, more particularly, wearable vegetable collecting devices, and to methods of collecting vegetables using such wearable vegetable collecting devices.

### BACKGROUND OF THE INVENTION

Vegetable collecting devices are known in the art. Typically, such vegetable collecting devices may consist of a receptacle configured to be grasped or actively held by a user in which the collected vegetables can be deposited and stored. However, the collection of vegetables using known vegetable collecting devices may be time consuming and tiresome.

It would be desirable to provide a vegetable collecting device that allows for a more efficient vegetable collection process.

### SUMMARY OF THE INVENTION

The wearable vegetable collecting device comprises:
a main body configured to be worn on a hand, wrist or arm, the main body comprising an attachment area; and
a receptacle attached to the attachment area, the receptacle comprising an opening whereby a vegetable can be deposited in the receptacle.

As used herein, the term “vegetable” should be construed as any plant or part of a plant. Non-limitative examples of vegetables are fruits (such as berries), nuts, seeds, roots and leaves.

As used herein, the term “plant” should be construed as a living organism of the kind exemplified by trees, shrubs, herbs, grasses, ferns and mosses, typically growing in a permanent site, absorbing water and inorganic substances through its roots, and synthesizing nutrients in its leaves by photosynthesis.

As used herein, the term “wearable” should be construed as intended to be externally disposed on or borne by a human body in order to perform a certain technical and/or aesthetical function. Generally, a wearable device can be distinguished from a device configured to be grasped or actively held, that is, a wearable device need not be grasped by a user's hands nor actively held by a human body part. As they may be easily carried on the human body, wearable devices may be a preferred configuration of portable devices.

By providing a main body that can be worn on a hand, wrist or arm and a receptacle attached to an attachment area of the main body, the wearable vegetable collecting device may be transported, without requiring an additional effort by a user, to a convenient location in which vegetable collection can be carried out.

The opening may be disposed relative to main body to allow for a vegetable collected at least by a thumb and an index finger of a hand to be dropped into the receptacle when the receptacle is held at an upright position and the main body is worn on such hand, on a wrist on the same body side as the hand or on an arm on the same body side as the hand.

As used herein, “body side” is construed as one of the two sides a human body is divided into. The human body comprises a left-hand side and a right-hand side.

The wearable vegetable collecting device may be appropriated disposed on a hand, wrist or arm to allow for the opening to be conveniently positioned relative to a user's fingers. This may facilitate the introduction of vegetables picked by a user into the receptacle. This may increase the efficiency of the vegetable collection process. This may be particularly beneficial for small-sized vegetables, such as berries and, preferably, blueberries, raspberries and blackberries.

The main body may comprise an elastic material. This may enable an improved adaptation of the main body to the hand, wrist or arm. The elastic material may be an elastic fabric.

The elastic fabric may be any suitable fabric. The elastic fabric may comprise one or more of: an expandable elastic fabric, a foamed elastic fabric, Nylon fabric, leather, synthetic leather and a thermally insulating flame and fire-resistant fabric.

The main body may be configured to be worn on a hand. This may be particularly efficient to enhance vegetable collection.

The main body may be a glove configured to be worn on a hand, the glove comprising a palm section configured to cover a palm of the hand and a back section opposite the palm section and configured to cover a back of the hand.

A glove may constitute a preferable solution to allow the main body to be worn on a hand in a secured and comfortable manner. The glove may also be desirable to protect the hand from vegetable comprising sharp parts, such as thorns.

The glove may comprise an elastic material, such as an elastic fabric. The glove may comprise a non-elastic material, such as non-elastic fabric. The glove may comprise a combination of elastic and non-elastic materials.

When the glove comprises a combination of elastic and non-elastic materials, the palm section may comprise a non-elastic material and the back section may comprise an elastic material. This configuration may give rise to an appropriate protection on a user's palm whilst conferring enough adaptability on the glove.

The main body may be a hand band configured to be worn on a hand. The hand band may constitute a compact, inexpensive an easy-to-wear main body.

As used herein, the term “band” refers to a loop of material configured to be disposed around a body part.

The hand band may be comprise an elastic material, such as an elastic fabric. This may allow for a suitable adjustment to the hand.

The main body may comprise a tongue and at least one finger sleeve attached to the tongue. The at least one finger sleeve may be configured for a user to introduce more than one finger into the at least one finger sleeve. Likewise, the at least one finger sleeve may be configured for a user to introduce a single finger into each at least one finger sleeve. When the at least one finger sleeve is configured for a user to introduce a single finger into each at least one finger sleeve, it is preferable that the main body comprise at least two finger sleeves. The main body may preferably comprise a first finger sleeve configured for a user to introduce a ring finger and a second finger sleeve configured for a user to introduce a little finger.

The provision of a main body comprising a tongue and at least one finger sleeve may be desirable to provide an easy-to-wear vegetable collecting device which can be manufactured with a reduced amount of material, such as fabric, and which offers sufficient stability during vegetable collection.

When the main body comprises a tongue and at least one finger sleeve, the tongue may be solidly attached to a receptacle. Therefore, an attachment area is formed at the union between the tongue and the receptacle.

The main body may comprise a wrist band configured to be worn a wrist of a user. The main body may comprise an arm band configured to be worn an arm of a user.

A configuration of main body comprising a wrist band or an arm band may be advantageous in that the main body is easily wearable on the human body while enabling the hand on the same body side as the wrist or arm to have more freedom of movement.

The wrist band may comprise an elastic material, such as an elastic fabric. The arm band may comprise an elastic material, such as an elastic fabric. Elastic wrist bands and arm bands may be desirable because they may allow for a suitable adjustment to respectively the wrist of a user and the arm of a user.

A stem may be attached to the wrist band at a joint. A stem may be attached to the arm band at a joint. The joint may be a removable joint. It may also be a permanent joint.

The stem may comprise a furthermost end which constitutes an attachment area of the main body comprising a wrist band or an arm band.

The stem may be beneficial to arrange the receptacle at a convenient position relative to the fingers to allow for an efficient vegetable collection.

The opening may be disposed relative to the main body to allow for at least four fingers to remain above the opening when the receptacle is held at an uptight position and the main body is worn on a hand, wrist or arm.

At used herein, the term “upright position” of the receptacle is construed as the position of the receptacle in which its longitudinal axis is disposed vertically, that is, aligned to gravity, and in which the opening is disposed at the uppermost end of the receptacle.

As used herein, the term “longitudinal” denotes the direction corresponding to the main longitudinal axis of the receptacle.

The term “transverse” refers to the direction that is perpendicular to the longitudinal axis. Any reference to the “cross-section” of the receptacle refers to the transverse cross-section unless stated otherwise.

The term “length” denotes the dimension of the receptacle or component of the receptacle in the longitudinal direction.

By allowing at least four fingers to be above the opening at such upright position, the wearable vegetable collecting device may advantageously be used to efficiently pick up and deposit vegetables into the receptacle, even if up to four fingers are used to pick up a certain piece of vegetable. This may be particularly beneficial for medium-sized vegetables, such as walnuts.

The longitudinal axis of the receptacle may be disposed substantially perpendicularly to a longitudinal axis of a hand of a user when then main body is worn on a hand, wrist or arm.

This may allow the longitudinal axis of the hand to be disposed substantially horizontally, that is, perpendicular to gravity, when the receptacle is held at an upright position. This may be beneficial to enable a more comfortable and efficient position of the hand of the user during vegetable collection. This may also enable more freedom of movement for the hand and a wrist of the user, as the receptacle may be disposed substantially below the hand and the wrist when held at an upright position.

When the main body is a glove, the attachment area may be advantageously disposed on the palm section.

When the main body is a glove, the glove may comprise at least one finger section configured to at least partially cover a finger when the glove is worn on a hand. This may help keep the fingers protected during vegetable collection, which may be beneficial when the vegetable comprises sharp parts, such as thorns.

When the main body is a glove, the glove may comprise a wrist closure. The wrist closure may ensure that the glove is tightly worn on a user's hand.

The wrist closure may comprise one or more of: a pair of hook and loop fabric fastening strips (such as “Velcro”), a zipper, a latch and one or more snaps.

The receptacle may be removably attached to the main body. This may allow for a more efficient storage, transportation and assembly of the wearable vegetable collecting device.

The attachment area may comprise an aperture. The receptacle may have a tab fitted into the aperture.

The provision of an aperture in the attachment area and a tab in the receptacle, such that the tab fits the aperture, may allow for a robust connection between the receptacle and the main body. Such connection may withstand the forces the wearable vegetable collecting device is typically subjected to during vegetable collection.

The tab may comprise a first protrusion and a second protrusion, the first and second protrusions being parallel to each other. This may contribute towards the robustness of the connection between the main body and the receptacle.

The receptacle may be configured to remain at a fixed position relative to the attachment area of the main body. This may be beneficial to enhance the robustness of the connection between the main body and the receptacle. This may also contribute to a more efficient introduction of certain vegetables into the receptacle.

The receptacle may be movable relative to the attachment area of the main body. This may be desirable to permit more versatility in the movement of the wearable vegetable collecting device while keeping the receptacle in a position that is suitable for the introduction and storage of vegetables.

The receptacle may comprise any suitable material.

The receptacle may comprise paper. It may also comprise cardboard. Paper and cardboard may be preferred because they may be inexpensive and non-toxic.

The receptacle may comprise a polymeric material. The polymeric material may be one of polypropylene, polyethylene and acrylonitrile butadiene styrene. These polymeric material may be advantageous since they may have optimised mechanical properties, they may be easy to process during manufacturing and they may be non-toxic.

When the receptacle is movable relative to the attachment area, the attachment area may comprise a pivot arm and the receptacle may comprise a tab configured to allow for a rotation of the receptacle around a rotation axis of the pivot arm.

The receptacle may taper, in a longitudinal direction, from the opening towards a distal end of the receptacle opposite the opening. Since the receptacle tapers from the opening towards the distal end, a stack of receptacles (and, in consequence, of wearable vegetable collecting devices) can be formed by placing the receptacles inside each other. This may facilitate the storage of the receptacles.

The receptacle may taper, in a longitudinal direction, from a distal end of the receptacle opposite the opening towards the opening.

A receptacle that tapers from the distal end towards the opening may be beneficial to facilitate that vegetables deposited inside the receptacle remain within the receptacle during vegetable collection.

The receptacle may be cylindrical. The receptacle may have any suitable cross-section. The receptacle may have a circular cross-section. The receptacle may have an elliptical cross-section. The receptacle may have a cross-section comprising at least two sections of ellipse with different eccentricities. When the receptacle has a cross-section formed of one or more ellipses, the eccentricity or eccentricities of the cross-section may be conveniently chosen for the type or types of vegetable to be collected.

The cross-section of the receptacle may have any suitable area. The cross-section may have an area between 10 square centimetres and 100 square centimetres, preferably between 15 square centimetres and 80 square centimetres, even more preferably between 20 square centimetres and 50 square centimetres. Such cross-sections may be useful for the storage of a large variety of vegetables that can be collected by user's fingers.

The receptacle may have any suitable length. The length of the receptacle may be between 5 cm and 20 cm, more preferably between 7 cm and 15 cm, even more preferably between 9 cm and 12 cm.

A distal end of the receptacle opposite the opening in a longitudinal direction may comprise a tear-off region.

The provision of the tear-off region may be advantageous to allow for an easier extraction of the collected vegetables from the receptacle.

The wearable vegetable collecting device may comprise a conveyor tube configured to be coupled to the distal end when the tear-off region is removed from the distal end.

Accordingly, the collected vegetables extracted from the receptacle through the gap left by the removal of the tear-off region may be efficiently transported to any other appropriate object, such as a larger container or a conveyor belt.

A method of collecting vegetables may be provided. The method comprises the steps of:
wearing any of the above wearable vegetable collecting devices on a hand, wrist or arm,
collecting a vegetable using one or more fingers,
depositing the collected vegetable in the receptacle.

Since the method includes the step of wearing any of the above wearable vegetable collecting devices, the method may be advantageous for the same reasons as the above wearable vegetable collecting devices. More particularly, the method may allow for a faster and less tiresome vegetable collection process.

### BRIEF DESCRIPTION OF THE DRAWINGS

These and other features and advantages of the invention will become more evident in the light of the following detailed description of preferred embodiments, given only by way of illustrative and non-limiting example, in reference to the attached figures:

FIG. 1 shows a perspective view of a wearable vegetable collecting device in which a main body is a glove.

FIG. 2 illustrates a perspective view of a wearable vegetable collecting device wherein an attachment area comprises a tab and a pivot arm.

FIG. 3 depicts a perspective view of a wearable vegetable collecting device in which a receptacle tapers from a distal end towards an opening.

FIG. 4 represents a perspective view of a wearable vegetable collecting device in which a receptacle comprises a tear-off region.

FIG. 5 illustrates a perspective view of the wearable vegetable collecting device of FIG. 4 further comprising a conveyor tube.

FIG. 6 depicts a perspective view of a wearable vegetable collecting device in which the main body is a hand band.

FIG. 7 shows a perspective view of a wearable vegetable collecting device in which the main body comprises a tongue, a first finger sleeve and a second finger sleeve.

FIG. 8 represents a perspective view of a wearable vegetable collecting device in which the main body is a wrist band.

FIG. 9 illustrates a receptacle comprising a rim section and a container section.

FIG. 10 shows a receptacle having a cross-section comprising two sections of ellipse with different eccentricities.

FIG. 11 depicts a receptacle having a cross-section comprising a single ellipse.

FIG. 12 shows a receptacle having a circular cross-section.

### DETAILED DESCRIPTION OF THE INVENTION

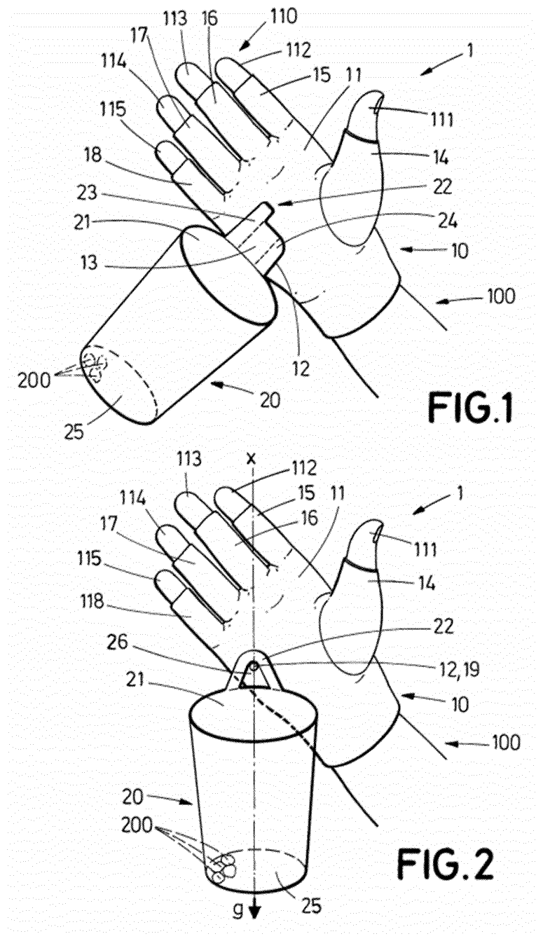

FIG. 1 shows a wearable vegetable collecting device 1. The wearable vegetable collecting device 1 comprises a main body 10 which, in the embodiment of FIG. 1, is a glove 10. The glove 10 is worn on a hand 110 of a user 100. The glove 10 comprises a palm section 11 which covers a palm of the hand 110 and a back section (not shown in FIG. 1) opposite the palm section 11 which covers a back of the hand 10. An attachment area 12 is disposed on the palm section 11.

A receptacle 20 is removably attached to the attachment area 12 of the glove 10. The receptacle 20 comprises an opening 21 whereby a vegetable 200 can be deposited in the receptacle 20.

The receptacle 20 tapers, in a longitudinal direction, from the opening 21 towards a distal end 25 of the receptacle 20 opposite the opening 21. Therefore, a stack of receptacles 20 (and, in consequence, of wearable vegetable collecting devices 1) can be formed by placing the receptacles 20 inside each other.

In the embodiment of FIG. 1, the opening 21 is disposed relative to the glove 10 to allow for a vegetable 200 collected at least by a thumb 111 and an index finger 112 to be dropped into the receptacle 20 when the receptacle 20 is held at an upright position. This may allow for an efficient vegetable collection process.

The glove 10 comprises five finger sections 14, 15, 16, 17, 18, each respectively partially covering a finger 111, 112, 113, 114, 115.

The attachment area 12 comprises an aperture 13 and the receptacle 20 comprises a tab 22 fitted into the aperture 13. The tab 22 comprises a first protrusion 23 and a second protrusion 24. The first 23 and second 24 protrusions are substantially parallel to each other. The attachment area 12, and more particularly the aperture 13, and the tap 22, more concretely the first 23 and second 24 protrusion, are configured to keep the receptacle 20 at a fixed position relative to the attachment area 12 of the glove 10.

FIG. 2 shows a wearable vegetable collecting device 1 identical to that of FIG. 1 except in that an attachment area 12 of a glove 10 and a tab 22 of a receptacle 20 are different to those of the device 1 of FIG. 1.

The attachment area 12 comprises a pivot arm 19. The tab 22 is configured to allow for a rotation of the receptacle 20 around a rotation axis of the pivot arm 19. In the embodiment of FIG. 2, the tab 22 comprises a slot 26. The pivot arm 19 is disposed on a rounded end of the slot 26 to allow for the rotation of the receptacle 20. Similarly, the tab 22 may be solid and may comprise a perforation though which the pivot arm 19 is disposed.

Since the configuration of the tab 22 and the attachment area 12 enables the receptacle 20 to move (more concretely, to rotate) relative to the attachment area 12, the receptacle 20 may be easily positioned such that its longitudinal axis X is oriented vertically, that is, aligned to gravity g, as shown in FIG. 2.

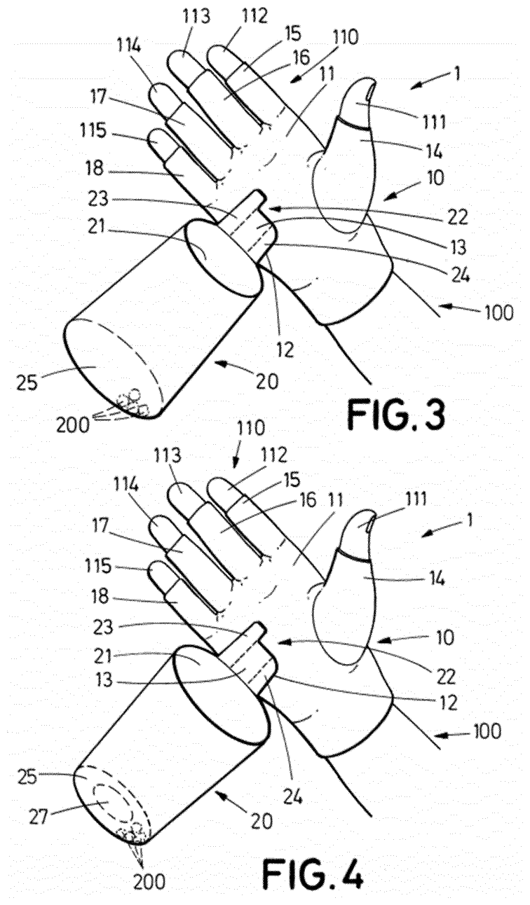

FIG. 3 shows a wearable vegetable collecting device 1 identical to that of FIG. 1 except in that a receptacle 20 tapers, in a longitudinal direction, from a distal end 25 of the receptacle opposite an opening 21 towards the opening 21. Therefore, the opening 21 has a smaller cross-sectional area than the distal end 25.

FIG. 4 shows a wearable vegetable collecting device identical to that of FIG. 1 except in that a distal end 25 comprises a tear-off region 27.

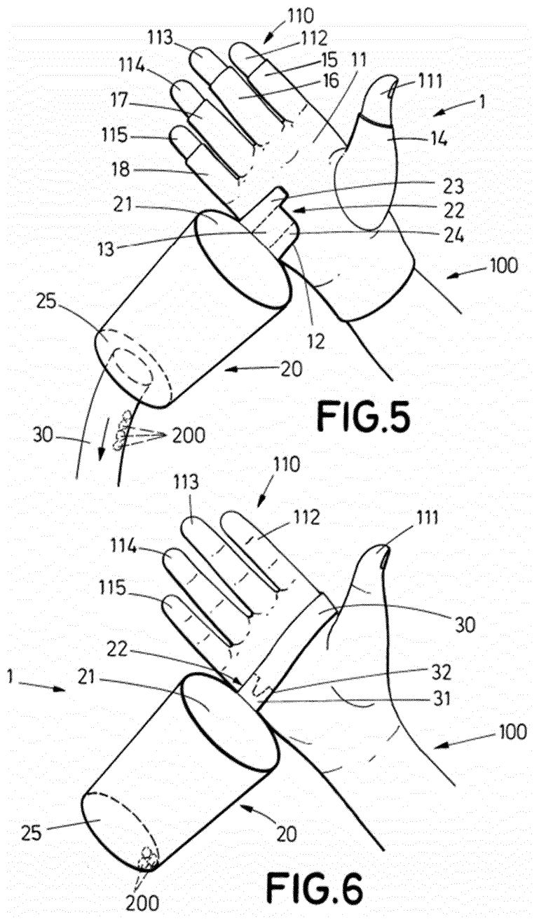

FIG. 5 shows the wearable vegetable collecting device 1 of FIG. 4 once the tear-off region 27 has been removed from the distal end 25. A conveyor tube 30 is coupled to the distal end 25 such that the vegetables 200 can be transported from a receptacle 20, through a gap left by the tear-off region 27 after its removal and along the conveyor tube 30 towards another appropriate object, such as a larger container or a conveyor belt.

The removal of the tear-off region 27 may also be useful to extract vegetables 200 from the receptacle 20 directly through the gap left by the tear-off region 27 after its removal, that is, without using a conveyor tube 30 or any other transportation element.

FIG. 6 shows a wearable vegetable collecting device 1. The wearable vegetable collecting device 1 comprises a main body 30 which, in the embodiment of FIG. 6, is a hand band 30. The hand band 30 is worn on a hand 110 of a user 100. The hand band 30 of the embodiment of FIG. 6 comprises an elastic material, which allows for a suitable adjustment to the hand 110. An attachment area 31 is disposed on the hand band 30. When the user 100 wears the hand band 10 on the hand 110, the attachment area 31 is preferably disposed on a region of a palm of the hand 110 near the little finger 115.

A receptacle 20 is removably attached to the attachment area 31. The receptacle 20 comprises an opening 21 whereby a vegetable 200 can be deposited in the receptacle 20. The receptacle 20 tapers, in a longitudinal direction, from the opening 21 towards a distal end 25 of the receptacle 20 opposite the opening 21.

In the embodiment of FIG. 6, the opening 21 is disposed relative to the hand band 30 to allow for a vegetable collected at least by a thumb 111 and an index finger 112 to be dropped into the receptacle 20 when the receptacle 20 is held at an upright position.

The attachment area 31 comprises an aperture 32 and the receptacle 20 comprises a tab 22 fitted into the aperture 32. The tab 22 is V-shaped. The attachment area 31, and more particularly the aperture 32, and the V-shaped tap 22 are configured to keep the receptacle 20 at a fixed position relative to the attachment area 31 of the hand band 30.

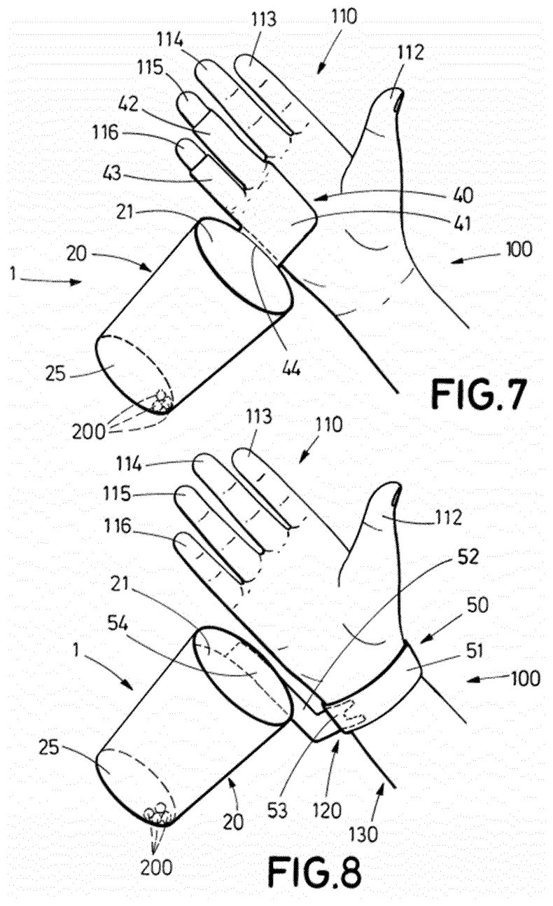

FIG. 7 shows a wearable vegetable collecting device 1. The wearable vegetable collecting device 1 comprises a main body 40 which, in the embodiment of FIG. 7, comprises a tongue 41, a first finger sleeve 42 and a second finger sleeve 43. The first 42 and second 43 finger sleeves are integrally attached to the tongue 41. The main body 40 is worn on a hand 110 of a user 100 by placing the tongue 41 on a palm of a hand 110 and by introducing the ring 115 and the little 116 fingers respectively into the first 42 and second 43 finger sleeves. The first 42 and second 43 finger sleeves are configured to tightly receive the ring 115 and little 116 fingers—hence, the wearable vegetable collecting device 1 can be easily worn on the hand 110 without a need for a bulky device.

The tongue 41 is solidly attached to a receptacle 20. Therefore, an attachment area 44 is formed at a joint between the tongue 41 and the receptacle 20.

The receptacle 20 comprises an opening 21 whereby a vegetable 200 can be deposited in the receptacle 20. The receptacle 20 tapers, in a longitudinal direction, from the opening 21 towards a distal end 25 of the receptacle 20 opposite the opening 21.

In the embodiment of FIG. 7, the opening 21 is disposed relative to the tongue 41 to allow for a vegetable collected at least by a thumb 111 and an index finger 112 to be dropped into the receptacle 20 when the receptacle 20 is held at an upright position.

FIG. 8 shows a wearable vegetable collecting device 1. The wearable vegetable collecting device 1 comprises a main body 50 which, in the embodiment of FIG. 8, comprises a wrist band 51 and a stem 52. The wrist band 30 is worn on a wrist 120 of a user 100. The band 51 may also be worn on an arm 130 of a user 100. The wrist band 51 of the embodiment of FIG. 6 comprises an elastic material, which allows for a suitable adjustment to the wrist 120.

The stem 52 is attached to the wrist band 51 at a joint 53. The joint 53 may be a removable joint. It may also be a permanent joint. Any of the examples of attachment areas explained above may be applied to the joint 53.

The stem 52 comprises a furthermost end 54 which constitutes an attachment area 54 of the main body 50.

A receptacle 20 is attached to the attachment area 54. The receptacle 20 comprises an opening 21 whereby a vegetable 200 can be deposited in the receptacle 20. The receptacle 20 tapers, in a longitudinal direction, from the opening 21 towards a distal end 25 of the receptacle 20 opposite the opening 21.

In the embodiment of FIG. 8, the opening 21 is disposed relative to the wrist band 51 and the stem 52 to allow for a vegetable 200 collected at least by a thumb 111 and an index finger 112 to be dropped into the receptacle 20 when the receptacle 20 is held at an upright position.

The attachment area 54 of the embodiment of FIG. 8 comprises an adhesive which provides the attachment between the stem 52 and the receptacle 20. The attachment area 54 is thus configured to keep the receptacle 20 at a fixed position relative to the stem 52.

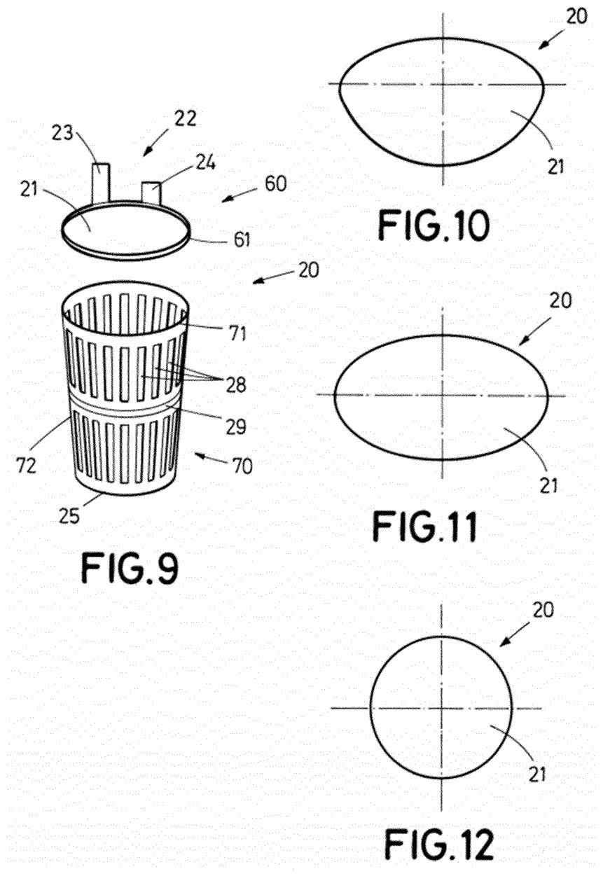

FIG. 9 illustrates a detailed embodiment of a receptacle 20. This receptacle 20 can be used in combination with any main body disclosed in this specification.

The receptacle 20 comprises a rim section 60 and a container section 70. The rim section 60 and the container section 70 are removably attachable to one another. In the embodiment of FIG. 9, a container edge 71 of the container section 70 is configured to be snap-fitted into a circumferential slot of a rim edge 61 of the rim section 60.

When the container edge 71 is snap-fitted into the rim edge 61, the rim edge 61 forms an opening 21 whereby a vegetable 200 can be deposited in the receptacle 20.

The rim section 60 comprises a tab 22 configured to be fitted into an aperture of an attachment area of a main body, as explained above for FIGS. 1, 3, 4 and 5. The tab 22 comprises a first protrusion 23 and a second protrusion 24. The first 23 and second 24 protrusions are substantially parallel to each other.

The container section 70 comprises a cylindrical wall 72 such that the container section 70 tapers, in a longitudinal direction, from the opening 21 towards a distal end 25 of the receptacle opposite the opening 21. Therefore, the opening 21 has a greater area than the distal end 25.

The cylindrical wall 72 comprises a plurality of slits 28. The slits 28 may be useful to confer flexibility on the cylindrical wall 72; they may also be beneficial to allow a user 100 to easily check the amount of vegetables within the receptacle 20.

The cylindrical wall 72 comprises a perimeter stripe 29 disposed transversally around the cylindrical wall 72. The perimeter stripe 29 may be advantageous to improve the mechanical stability of the receptacle 20, such that the receptacle 20 may withstand the forces the wearable vegetable collecting device 1 is typically subjected to during vegetable collection.

FIG. 10 shows a cross-section of a receptacle 20. The cross-section comprises two sections of ellipse having different eccentricities.

FIG. 11 shows a cross-section of a receptacle 20. The cross-section consists of a single ellipse.

FIG. 12 shows a circular cross-section of a receptacle 20.

1. A wearable vegetable collecting device comprising:
a main body configured to be worn on a hand, wrist or arm, the main body comprising an attachment area; and
a receptacle attached to the attachment area, the receptacle comprising an opening whereby a vegetable can be deposited in the receptacle.

2. The wearable vegetable collecting device of claim 1, wherein the opening is disposed relative to main body to allow for a vegetable collected at least by a thumb and an index finger of a hand to be dropped into the receptacle when the receptacle is held at an upright position and the main body is worn on such hand, on a wrist on the same body side as the hand or on an arm on the same body side as the hand.

3. The wearable vegetable collecting device of claim 1, wherein the main body is a glove configured to be worn on a hand, the glove comprising a palm section configured to cover a palm of the hand and a back section opposite the palm section and configured to cover a back of the hand.

4. The wearable vegetable collecting device of claim 3, wherein the opening is disposed relative to the glove to allow for at least four fingers to remain above the opening when the receptacle is held at an uptight position and the glove is worn on the hand.

5. The wearable vegetable collecting device of claim 1, wherein the main body is one of a hand band configured to be worn on a hand, a wrist band configured to be worn on a wrist and an arm band configured to be worn on an arm.

6. The wearable vegetable collecting device of claim 1, wherein the main body comprises a tongue and at least one finger sleeve attached to the tongue, and wherein the at least one finger sleeve is configured for a user to introduce at least one finger into the at least one finger sleeve.

7. The wearable vegetable collecting device of claim 1, wherein the receptacle is removably attached to the main body.

8. The wearable vegetable collecting device of claim 1, wherein the attachment area comprises an aperture and the receptacle comprises a tab fitted into the aperture, the tab preferably comprising a first protrusion and a second protrusion, the first and second protrusions being preferably parallel to each other.

9. The wearable vegetable collecting device of claim 1, wherein the receptacle is configured to remain at a fixed position relative to the attachment area of the main body.

10. The wearable vegetable collecting device of claim 1, wherein the receptacle is movable relative to the attachment area of the main body and wherein the attachment area preferably comprises a pivot arm and the receptacle preferably comprises a tab configured to allow for a rotation of the receptacle around a rotation axis of the pivot arm.

11. The wearable vegetable collecting device of claim 1, wherein the receptacle tapers, in a longitudinal direction, from the opening towards a distal end of the receptacle opposite the opening.

12. The wearable vegetable collecting device of claim 1, wherein the receptacle tapers, in a longitudinal direction, from a distal end of the receptacle opposite the opening towards the opening.

13. The wearable vegetable collecting device of claim 1, wherein the receptacle comprises a distal end opposite the opening in a longitudinal direction, and wherein the distal end comprises a tear-off region.

14. The wearable vegetable collecting device of claim 14, further comprising a conveyor tube configured to be coupled to the distal end when the tear-off region is removed from the distal end.

15. A method of collecting vegetables comprising the steps of:
wearing the wearable vegetable collecting device of claim 1 on a hand, wrist or arm,
collecting a vegetable using one or more fingers,
depositing the collected vegetable in the receptacle.
